(19) United States
(12) Patent Application Publication
(10) Pub. No.: US 2019/0201282 A1
(43) Pub. Date: Jul. 4, 2019

(54) SPA CONTROL WITH NOVEL HEATER MANAGEMENT SYSTEM

(71) Applicant: Jerrell Penn Hollaway, Sebastian, FL (US)

(72) Inventor: Jerrell Penn Hollaway, Sebastian, FL (US)

(21) Appl. No.: 15/860,732

(22) Filed: Jan. 3, 2018

(51) Int. Cl. A61H 33/00

(52) U.S. Cl. CPC A61H 33/0095; A61H 33/005; A61H 2201/501; A61H 2201/5082; A61H 2201/0228; A61H 2201/0207

(57) ABSTRACT

A spa control system where the spa's heater is disconnected from the power source anytime the water in the heater is at a higher temperature than that set by the user or more than an absolute temperature. Since the control system has a regular temperature management control, this will only occur due to a problem in the spa or the control system itself. Independent paths between a pair of temperature sensors in the heater and the relays that connect line voltage to the heater are provided to meet the safety requirements of Underwriters Laboratories (UL). Two sensors in the heater are co-located in a metal tube, placed near the heater element. A novel flow test to prevent dry fire is also taught.

This application is a continuation-in-part of application Ser. No. 14/995,331 filed Jan. 14, 2016, Jerrell Hollaway single inventor

### BACKGROUND OF THE INVENTION

One of the biggest safety concerns with a spa, or hot tub, is the management of the heater. For several years all spa controls used a pressure switch to determine that the spa's pump was running and circulating water in the spa through the heater. If a spa was turned on without sufficient water, for example, the electric heating element could quickly overheat, causing damage to the spa and nearby structures. A pressure switch could prevent this from happening. The only problem was that the switch itself was often unreliable.

Underwriters Laboratories (UL) insists that a temperature sensing device of some kind be placed on or within the heater to recognize an overheating problem and to quickly disengage the heater. This device was to be in addition to the primary heater control. Because of this requirement, most spa controllers were built with a temperature sensor in the spa water and another sensor on the heater. The sensor on the heater would declare a problem whenever the temperature reached a predetermined level, usually 116 to 118 degrees F.

An approach was taught by Cline et al in U.S. Pat. No. 6,282,370 wherein a pair of sensors were placed on opposite ends of the heater and the heater was turned off whenever there was a prescribed difference between the values of the sensors, meaning that insufficient water was flowing through the heater.

A better approach was taught by Hollaway in U.S. Pat. No. 8,392,027. This approach was to use a single sensor inside the heater, near the heating element, and to monitor the temperature for a rapid rate of change. If the rate of change was greater than a normal rate it was because the flow of water through the heater was too slow or water ws missing.

The present invention teaches yet another approach that is simpler and safer than anything else offered to date. A main goal of this invention is to avoid unnecessary high temperatures inside the heater or the spa.

### SUMMARY OF THE INVENTION

The heater management system of the present invention solves the safety requirements of UL in an entirely new way. The method of this invention is to use a temperature limiting circuit that operates at relative low temperatures. This is made possible by co-located sensors mounted together in a metal tube that penetrates a wall of the heater housing. The metal tube places the sensors very near the heating element of the heater such that a rapid response occurs whenever there is a fault. With this design, a decision to activate the temperature limiting circuitry can be made as soon as the measured temperature is only a few degrees higher than normal. The temperature limiting circuit is activated only if the heater is still energized and drawing current. Current through the heater can be determined by several methods. One method is to turnoff everything in the spa and then measure the incoming current. Another method is to briefly stop the flow of water through the heater, with everything off, and see if there is a significant temperature rise within the heater.

A heat rise indicates that the heater is still thawing current and it is time to employ the temperature limiting circuitry.

The overheat protection is provided by having two independent temperature sensors coupled to a microprocessor that controls two relay drivers which, in turn, control two independent relays connected between the electrical service lines and the heater element itself The novel part of this invention is the way that the heater programming detects overheating and shuts down electrical power to the heater. Unlike some of the systems previously described which relied on temperature differentials between two sensors, or a high rate of temperature change measurement that indicates a runaway electrical heater, the present invention just compares the water temperature in the heater to the temperature setting provided by the user, or to an absolute value that is within UL requirements. If the heater temperature is a prescribed amount higher than the set temperature, or the UL limit for temperature, there has to be a mechanical failure of some sort in the spa or the controller itself In any event, the heater is turned off and the spa is allowed to cool.

### BRIEF DESCRIPTION OF THE DRAWINGS

FIG. 1 is a block diagram of the temperature limiting circuit within the controller.

### DETAILED DESCRIPTION OF A FAVORITE EMBODIMENT

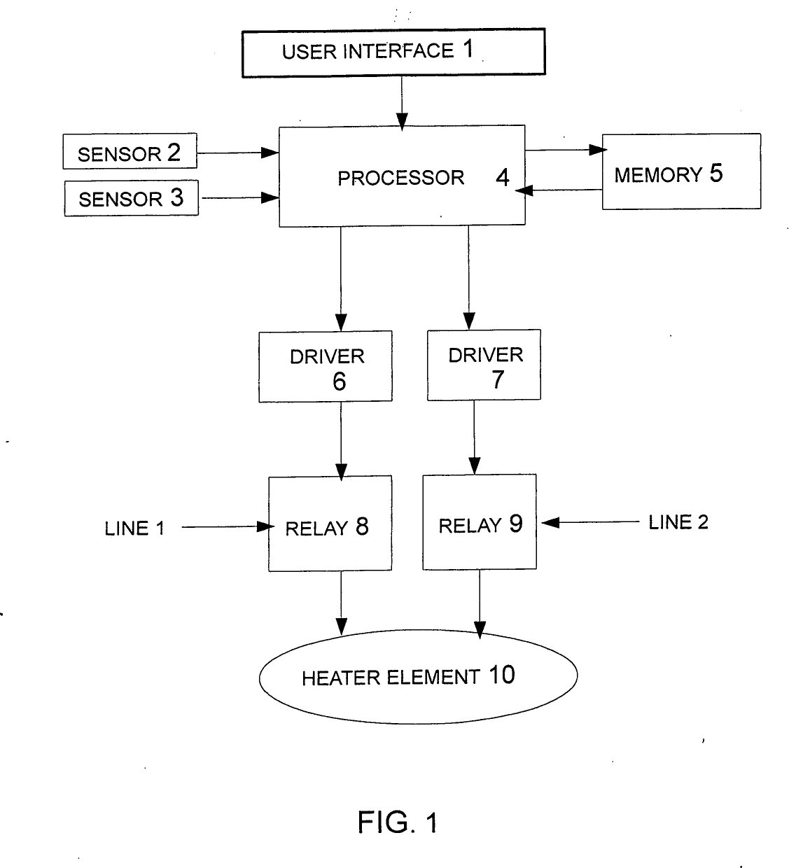

Referring now to FIG. 1, a user interface 1 is provided for the user to set a desired temperature for the water in the spa. This setting is stored in memory 5 for later comparison with the actual water temperature.

Sensor 2 and sensor 3 are mounted within the heater, as close as practical to the heating element. It is desirable that 2 and 3 share a common housing, such as a metal tube. Both 2 and 3 are able to measure the water temperature near the element and be compared to each other for accuracy. If the difference in readings between the sensors is too great, the heater cannot be turned on, since one or both of the sensors must be defective.

Processor 4 receives the values from 2 and 3 and determines if the water is cool enough to allow heating element 10 to be energized. This is accomplished with signals from processor 4 activating relay drivers 6 and 7 and the drivers closing relays 8 and 9, which couple lines 1 and 2 to heater element 10. In some cases relay drivers 6 and 7 may not be necessary. If the water needs to be heated, a separate heat control relay is activated, as is well known. After electrical power is applied to heater element 10, sensors 2 and 3 continually monitor the water temperature inside the heater. When the water has heated to the desired temperature, power to heater element 10 is removed by opening the heat control relay. If the temperature inside the heater is later found to be higher than the user setting by, say, 4 degrees or higher, than the UL limits, it is only because of a failure of some sort in the rest of the spa, such as a stuck relay. To meet the safety requirements of UL, processor 4 must remove signals to 6 and 7 and the heater element must be de-energized until the problem is identified and fixed. If the heater element is already de-energized no action is required.

It should be noted that relays 8 and 9 may be replaced with other types of power switches, such as TRIACS. Likewise, the functions of memory 5 may be performed by many other devices.

In another favorite embodiment, the elements of the invention shown in FIG. 1 are the same, but a different approach is used to de-energize the heater while the water inside the heater is still not excessively hot. The approach is to use the temperature limiting circuit in FIG. 1 to open relays 8 and 9 as soon as the water temperature inside the heater is approaching UL limits for water on the suction side of the pump. That temperature is currently restricted to 104 F plus 5 F.

In the past, spa manufactures have used a much higher temperatures as a decision point for employing a temperature limiting circuity, typically 116-118 F. This made sense due to the uncertainty of the measurements and the lack of a way to confirm the measurements. The main problem, however, was the fact that the heater was already quite hot before any action was taken. There was often little time to react and avoid damage to the spa.

To absolutely eliminate the risk of dry fire from lack of water in the heater, a novel flow test is used prior to each full heater element activation. This test consists of only two steps. The first step is to briefly activate (2-3 seconds) the heater element when heat demand is established. This occurs after a short run of the filter pump and with the pump still running. Step two is to simply monitor the heater temperature for a short period of time (15-30 seconds). A rise in temperature (2-5 degrees) in this short period means that there is either no water in the heater or no circulation. The heater element is then not energized further, a safety message is displayed, and the heater function cannot be attempted again until the system is manually reset.

No significant change in temperature means that the heater contains water and the water is moving. The heater element can now be activated normally for a long period of time. Thusly, a flow test, transparent to the user, is performed prior to each activation of the heater element.

The present invention uses two co-located sensors that monitor each other and assure that the reported temperatures are accurate. With trusted accuracy, there is no reason not to use the temperature limiting circuitry at lower temperatures and thereby avoiding any risk from elevated temperatures. There is already evidence of a problem because the heater temperature is in excess of the controller's highest set point, so early intervention is appropriate.

UL allows a water temperature of 122 F plus 5 F to exit the heater and enter the spa through the spa jets. If this temperature is allowed for a period of time, however, the water temperature within the spa will increase past the allowable water temperature of 109 F on the suction side of the pump. This violation of UL requirements-can best be avoided with the present invention by limiting the water within the heater to 109 F or less.

The benefits of activating the temperature limiting circuitry at lower temperature are many.

First of all, a lengthy flow test prior to energizing the heater is unnecessary. Waiting is eliminated, as well as extra energy usage. Pump life is improved. Most of the usual messages on the spa panel are also eliminated. There will no longer be “hi-limit”, “overheat” , or “flow” messages.

I claim:

1. A spa heater management system that prevents overheating of the spa heater by comparing the heater temperature with the user set temperature and employing a temperature limiting circuit to de-energize said heater whenever the temperature inside the heater is higher than the user set temperature by a prescribed amount of temperature comprising:
(a) an interface that allows a user to select a set temperature for the spa water,
(b) memory for storing said setting,
(c) one or more temperature sensors mounted within the heater housing,
(d) a processor coupled to said sensors for receiving values from said sensors and comparing said values with said temperature setting in memory,
(e) relays, or other power switching means, coupled between said processor, a heater element, and electrical service lines for the purpose of disconnecting said electrical lines from said heater element whenever said sensors detect a temperature that is a prescribed amount higher than said set temperature while said heater element is still energized.

2. The system in claim 1, wherein said temperature sensors are located in a common housing and said housing is located adajacent to said heater element.

3. The system in claim 1, wherein said user interface is an input panel.

4. The system in claim 1, wherein said memory is combined with said processor in a common package.

5. The system in claim 1 wherein all pumps in the spa are also de-energized whenever said temperature inside said heater is greater than a prescribed temperature.

6. A spa heater management system that prevents overheating of the spa heater by activating a temperature limiting circuit whenever said heater temperature is higher than a prescribed temperature and said heater element is still energized comprising:
(a) two or more temperature sensors co-located within the heater housing,
(b) a processor coupled to said sensors for receiving values from said sensors,
(c) relays, or other power switching means, coupled between said processor, a heater element, and electrical service lines for the purpose disconnecting said electrical lines from said heater element whenever said sensors detect a temperature that is greater than a prescribed temperature.

7. The system in claim 6, wherein said prescribed temperature is higher than UL requirements by a prescribed amount.

8. The system in claim 6, wherein said temperature limiting circuit is activated only after unwanted current through the heater is verified by either a current measurement or by observing a continuing heat rise after water circulation through the heater is stopped.

9. The system in claim 6, wherein all pumps in the spa are also de-energized whenever said temperature within said heater is greater than a prescribed temperature.

10. A spa heater management system that determines the presence of moving water in a spa heater prior to full activation of said heater by:
(a) circulating water through said heater for a prescribed amount of time,
(b) with circulation continuing, energizing heater element for a prescribed amount of time,
(c) with said element de-energized, monitoring temperature within said heater for a prescribed period of time,
(d) if said temperature within said heater increases by a prescribed amount within said period, said heater element is not energized for a longer period of time.
